(19) United States
(12) Patent Application Publication
(10) Pub. No.: US 2020/0136930 A1
(43) Pub. Date: Apr. 30, 2020

(54) APPLICATION ENVIRONMENT PROVISIONING

(71) Applicant: CA Software Österreich GmbH, Wien (AT)

(72) Inventors: Peter Miklos Szulman, Baden (AT); Markus Holzer, Modling (AT); Stefan Pomajbik, Vienna (AT)

(73) Assignee: CA Software Österreich GmbH, Wien (AT)

(21) Appl. No.: 16/169,314

(22) Filed: Oct. 24, 2018

(51) Int. Cl. H04L 12/24; G06F 9/50; H04L 29/08; G06F 8/60; G06F 9/455

(52) U.S. Cl. CPC H04L 41/5054; H04L 41/5048; H04L 41/5096; G06F 9/5077; G06F 2009/45583; G06F 8/60; G06F 9/45558; G06F 2009/45562; H04L 67/34

(57) ABSTRACT

According to at least one embodiment, an application environment is provisioned. In some embodiments, a stack template is accessed in response to a request to provision the application environment, with the stack template defining provider-independent configuration information for a particular stack. A deployment target template corresponding to the stack template is accessed, with the deployment target template defining provider-independent configuration information for middleware. A provisioning workflow is selected based at least on stack provider information indicated by the stack template, with the stack provider information indicating an infrastructure for provisioning the particular stack indicated by the stack template. A stack is provisioned on the infrastructure based on the selected workflow, the stack template, and the stack provider information, and middleware is then on the provisioned stack based on the deployment target template.

### BACKGROUND

The present disclosure relates in general to the field of computing systems, and more specifically, to application environment provisioning in computing systems.

Modern software systems often include multiple programs or applications working together to accomplish a task or deliver a result. An enterprise can maintain several such systems. Further, development times for new software releases are shrinking allowing releases to be deployed to update or supplement a system on an ever-increasing basis. Some enterprises release, patch, or otherwise modify their software code dozens of times per week. Further, enterprises can maintain multiple servers to host their software applications, such as multiple web servers deployed to host a particular web application. As updates to software and new software are released, deployment of the software can involve coordinating the deployment across multiple machines in potentially multiple geographical locations.

### BRIEF SUMMARY

According to at least one embodiment, an application environment is provisioned. In some embodiments, a stack template is accessed in response to a request to provision the application environment, with the stack template defining provider-independent configuration information for a particular stack. A deployment target template corresponding to the stack template is accessed, with the deployment target template defining provider-independent configuration information for middleware. A provisioning workflow is selected based at least on stack provider information indicated by the stack template, with the stack provider information indicating an infrastructure for provisioning the particular stack indicated by the stack template. A stack is provisioned on the infrastructure based on the selected workflow, the stack template, and the stack provider information, and middleware is then on the provisioned stack based on the deployment target template.

### BRIEF DESCRIPTION OF THE DRAWINGS

FIG. 1 is a simplified schematic diagram of an example computing system including an example deployment automation system in accordance with at least one embodiment.

FIG. 2 is a simplified block diagram of an example computing system including an example deployment automation engine in accordance with at least one embodiment.

FIG. 3 is a simplified diagram of an example model for application environment provisioning and application deployment within an example release automation system an example in accordance with at least one embodiment.

FIGS. 4A-4C simplified block diagrams of various implementations of stacks provisioned on stack provider hardware infrastructure in accordance with at least one embodiment.

FIG. 5 is a simplified block diagram illustrating relationships between an application and an environment blueprint in accordance with at least one embodiment.

FIG. 6 is a simplified block diagram showing example relationships between component templates, stack templates, deployment target templates, and stack provider information in accordance with at least one embodiment.

FIG. 7 is a simplified block diagram illustrating example process of selecting a provisioning workflow based on a stack template, a deployment target template, and stack provider information in accordance with at least one embodiment.

FIG. 8 is a flow diagram of an example process of provisioning an application environment in accordance with at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

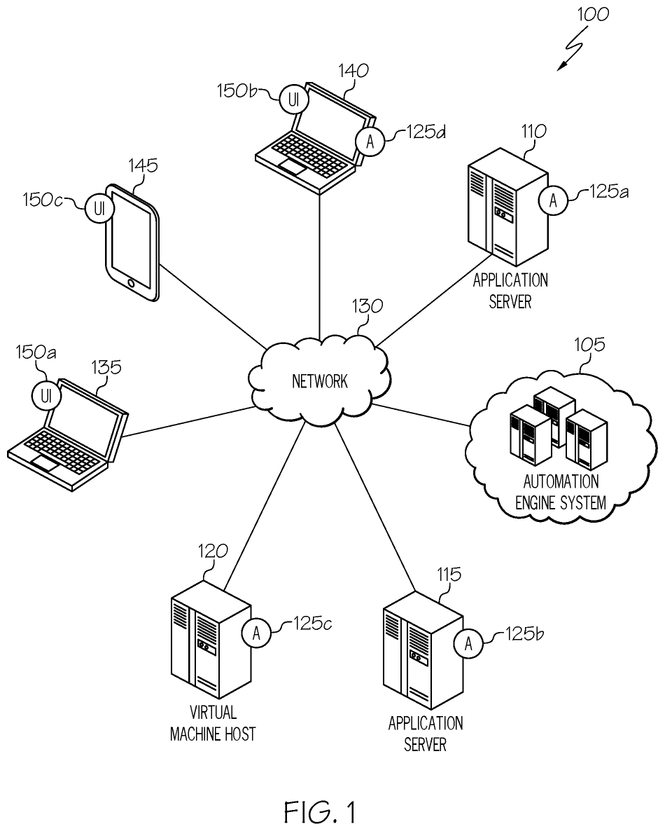

Referring now to FIG. 1, a simplified block diagram is shown illustrating an example computing environment 100 including an example automation engine system 105. The automation engine system 105 may be implemented on one or multiple host server devices and may flexibly implement a variety of software automation solutions and applications including release automation, workload automation, and automated service orchestration. An automation engine system may implement an automation engine implemented through a collection of interconnected work processes (hosted on one or more of the servers of the automation engine system 105) and communication processes (hosted on one or more the servers of the automation engine system 105). The work processes may be configurable to perform tasks to automate a variety of tasks on a computing system local to or remote from the automation engine system 105. For instance, an automation engine hosted on automation engine system 105 may automate workflows utilizing software applications, scripts, applets, or other software programs hosted on one or multiple different target computing systems, such as application server systems (e.g., 110, 115). In other instances, the automation engine may be utilized to orchestrate a service or automate the deployment and installation of a new software release on one or more of these systems (e.g., 110, 115) or other computing systems (e.g., a virtual machine or container-based host system (e.g., 120)), among other examples. Hosts and server systems may also be implemented on personal computing devices (e.g., 140), Internet of Things (IoT) devices, smart home systems, media consoles, smart appliances, and other computing systems, which may interface with an automation engine (on automation engine system 105) over one or more networks (e.g., 130) in connection with workflow automation, release automation, service orchestration, or other software automation applications supported by the automation engine.

In some implementations, agents (e.g., 125a-d) may be provisioned on host systems (e.g., 110, 115, 120, 140) to provide a hook for the automation engine to control operating system tasks or other operations and functionality provided on a host system through an operating system, hypervisor, application, or other software program, which may facilitate a workflow automation, release automation, service orchestration, or other software automation implementation. An automation engine may communicate with various agents deployed within host systems (e.g., 110, 115, 120, 140), for instance, through communication processes implementing the automation engine. In some implementations, communication processes may support and implement network communications (e.g., over one or more networks (e.g., 130)) between the computing system(s) (e.g., 105) hosting the work processes and other components of the automation engine. Further, in some implementations, user interfaces (e.g., 150a-c) may be defined in connection with the automation engine, which may be accessed on one or more user computing devices (e.g., 135, 140, 145), for instance, as a web-based or browser-implemented user interface. Users may provide inputs and define parameters for an automation implemented by the automation engine through these UIs (e.g., 150a-c). The inputs may be routed to one or more of the work processes of the automation engine using the communication processes of the automation engine, to allow for the definition of user-customized automations and even the definition of new or customized automations provided through the automation engine, among other examples.

In general, “servers,” “clients,” “computing devices,” “network elements,” “database systems,” “user devices,” and “systems,” etc. (e.g., 105, 110, 115, 120, 135, 140, 145, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, zOS, etc., as well as virtual machines and emulators adapted to virtualize execution of a particular operating system, as well as container-based operating environments (e.g., Docker containers, Kubernetes containers, etc.), and customized and proprietary operating systems among other examples.

Further, servers, clients, network elements, systems, and computing devices (e.g., 105, 110, 115, 120, 135, 140, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, an automation engine system 105, application server (e.g., 110, 115), host server 120, or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Through the advent of cloud and distributed computing architectures, together with agile software development paradigms, the management and implementation of software systems by enterprises has become increasingly complex. For instance, as computing systems migrate to cloud or hybrid cloud environments, managing workflows and deployment of new software may be more complex and costly without information technology automation. Further, given the rapid pace of software innovation, versioning, and updates, the pace at which software is released and orchestrated has likewise increased. For instance, in the case of release automation, releases and updates may be frequent, complex, and expensive to deploy in modern software systems. Managing the potentially thousands of software releases, even relating to a single entity's (e.g., enterprise's) system, can be difficult and exact costs on the very operability of the system. Such releases include both releases of new software systems as well as updates or patches to existing software. Valuable information technology (IT) personnel and resources are dedicated within some enterprises to developing and carrying-out these deployments. Traditionally, human users are employed throughout the process of the deployment. Further, human IT resources are not only expensive, but error prone, resulting in some deployments which are incorrect and that may need to be re-deployed, further consuming time and personnel resources. Additionally, some systems may be sensitive to down periods that may be required in order to allow deployment of new software releases on the system, among other complexities, costs, and variables. Similar complexities and costs are introduced when considering the orchestration of new services, managing workflows in transactions to be handled and developed using a software system, among other example considerations.

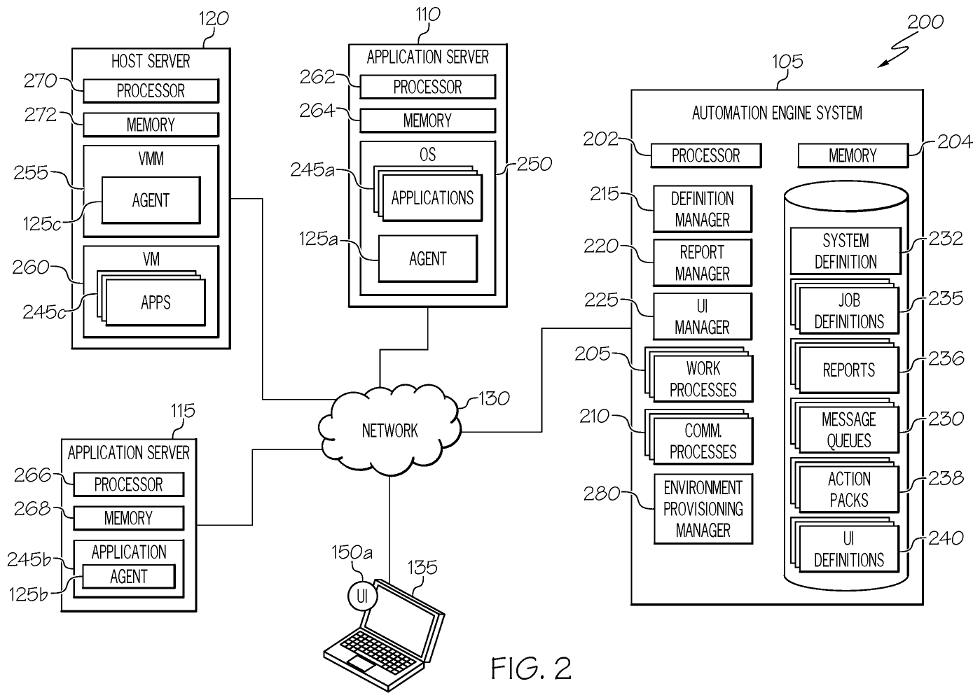

Automation tools and processes may be purpose built to handle common automation tasks, however, given the diversity and continuing evolution of enterprises' software systems, specialized, purpose-built automation tools are often ill-equipped to adapt to the ever-changing landscape of modern software products and systems. In some implementations, a flexible, scalable, and configurable automation engine may be provided, which is capable of being used, reused, and repurposed, dynamically, to provide a single automation platform capable of handling and be extended to handle a wide and diverse array of automation workloads and tasks. At least some of the systems described in the present disclosure, such as the systems of FIGS. 1 and 2, can include functionality providing at least some of the above-described features that, in some cases, at least partially address at least some of the above-discussed issues, as well as others not explicitly described.

For instance, in the example of FIG. 2, a simplified block diagram 200 is shown illustrating an example environment including an example implementation of an automation engine system 105. An automation engine implemented using the automation engine system 105 may be composed of a collection of work processes 205 and communication processes 210. Work processes (e.g., 205) are server processes implemented within the automation engine to perform the actual server work in various automations, such as activating, generating, and executing tasks within a given automation job, together with monitoring the status of the tasks and collecting information (and generating report data) relating to the completion of these tasks. Work processes 205 may retrieve tasks from a queue, with the tasks including logic executable by the work process to cause the work process to perform a particular type of task. When the work process 205 accesses a next task from the queue, it may retrieve corresponding logic and perform the next task, which may be the same or a different type of task than the work process's previously performed task. Indeed, the flexibility of the work processes allow a configurable mix of tasks and corresponding jobs to be handled by the collection of the work processes 205 in the automation engine, allowing the automation engine to respond dynamically to what may be a changing and diverse workload the automation engine is called on to handle. In other instances, work processes may be configured to be dedicated to handling particular types of high priority or low latency tasks, such that all of the work process's bandwidth is directed toward these types of tasks in the automation engine's workload (e.g., despite the work process being otherwise operable to handle potentially any one of the variety of tasks in jobs handled by the automation engine).

Further, one of the work processes implemented in the automation engine may be designated as the “primary” work process. A primary work process, in some examples, may be designated at the launch of the automation engine (e.g., based on the work process being the first to start) and this primary work process may be assigned special tasks based on its designation as the primary process, such as central work process tasks. In some cases, the primary work process may be tasked with autonomously assigning roles to additional work processes as they are started within the automation engine. In some implementations, work processes may be assigned roles to filter the types of tasks the respective work process is to handle. For instance, some work processes may be assigned (e.g., by the primary work process) to perform an output server role to handle outputs such as storing log messages and reports generated in the automation engine within a database of the automation engine. Another example server role which may be assigned to work processes may be a resource calculation role to perform tasks such as calculating calendar objects, perform deadlock avoidance, and other tasks, which involve calculations, among other examples. In some implementations, separate queues may be maintained in the automation engine database for each server role, such that tasks of a given work process are extracted from the specific queue corresponding to the work process's assigned role, among other example features and implementations.

Communication processes (e.g., 210) are additional server processes running on one or more computing systems (e.g., 105) implementing an instance of an automation engine. Communication processes 210 may handle communication between agents (e.g., 125a-c)), user interfaces (e.g., 150a), and work processes (e.g., 205) in connection with the automation engine. Communication processes hold the connections to the agents and the user interfaces. In some implementations, all communication between agents and UIs may be exclusively performed through the communication processes 210. In some implementations, port numbers of the systems hosting the automation engine may be assigned to respective work processes and communication processes. All of the server processes (e.g., work processes 205 and communication processes 210) may communicate with each other. Such an architecture can ensure flexibility and fault tolerance, allowing remaining processes to assume the queued tasks of another process in the event the other process fails, among other example features and advantages.

As noted above, a communication process can connect with agents (e.g., 125a-c) and UIs (e.g., 150a) to facilitate the communication between the agents and UIs and various work processes (e.g., 205) of an automation engine implementation. Agents may be implemented on target systems (e.g., 110, 115, 120) to expose functionality of an operating system (e.g., 250), application (e.g., 245b), virtual machine manager (e.g., 254), or other software program to the automation engine. Accordingly, agents may be implemented according to the specific features of the target software component (e.g., 245b, 250, 254, etc.). As an example, different agents may be provided for instrumentation on any one of a variety of different operating systems, such as agents specific to Windows, Linux, iOS, zOS, etc., among other examples. In some implementations, agents may initiate connections with one of the communication processes provided in an automation engine. For instance, an agent may open a TCP/IP connection with one of the communication processes of the automation engine. In some implementations, each agent may connect to a single one of the communication processes, while each communication process may be connected to multiple agents and/or user interfaces. Communications between the agent and a communication process may be encrypted.

As discussed in the examples above, a collection of work and communication processes may be provided in an automation engine system. In some cases, it may be advantageous to host the work processes 205 and communication processes 210 on multiple nodes or computing devices, as this can enhance fault tolerance of the automation engine and boost efficiency and reliability through the distribution of these processes over several computers. In some implementations, a potentially unlimited number and variety of work and communication processes may be implemented in a single automation engine instance. Further, by adding processes it is possible to adjust to growing use of the automation engine system. For instance, should a heavy workload exist or be introduced due to the number of logged-on agents and/or UIs, the number of communication processes can be increased. Likewise, should the number of automation engine system tasks become too burdensome, the number of work processes can be increased, among other example advantages.

As further illustrated in FIG. 2, an example automation engine system 105 may include one or more data processing apparatus (e.g., 202), one or more computer memory elements 204, and other components and logic, implemented in hardware circuitry and/or software to implement an automation engine instance. For instance, a definition manager 215 may be provided, through which a system definition file 232 may be accessed, modified, and/or defined. A system definition 232 may define the number of work processes 205 and communication processes 210 within an automation engine instance, as well as detail the individual computing systems hosting these server processes, the ports assigned to each process, among other information utilized to define an automation engine instance. A definition manager 215 may additionally access and/or define job definitions, which may correspond to automation jobs that may be performed by the automation engine. The job definitions 235 may additionally detail the combination of automation tasks and the target systems involved in the performance of these tasks in the furtherance of such automation jobs. Automation jobs may provide the information to be loaded into work queues consumed by work processes 205 in the automation engine. In some cases, automation jobs may be packaged in action packs (e.g., 238), which may be pre-generated packages of common types of automations, which may be reused and redeployed in various customers' respective automation engine instances. An individual instance of an automation engine may allow a user or manager to parameterize the action pack to enable the action pack's use within a particular customer's system (with its component target systems) (e.g., using definition manager 215). In some implementations, a report manager 220 may also be provided, which may enable user access to reports 236 and other data generated through the execution of various automation jobs by the automation engine (e.g., as generated by work processes 205 within the automation engine). A UI manager 225 may also be provided, in some implementations, to allow users or managers to define new UIs or parameterize UI templates for use in providing UIs (e.g., 150a) that are to interface with and be used in connection with automation jobs performed by an automation engine deployment. UI definitions 240 may be generated and maintained by the automation engine system 105 to form the basis of these UIs (e.g., which may be presented through web- or browser-based interfaces on potentially any user endpoint device (e.g., 135) capable of connecting to the automation engine over a private or public network (e.g., 130)). User devices may also be used to assist in the development of software applications and application components, which may be deployed into a target environment using the automation engine. For instance, one or more development tools (e.g., 250), such as an integrated development environment (IDE) may be hosted on a user device (e.g., 135). In some instances, functionality provided through the automation engine may be exposed to and accessible through an enhanced development tool (e.g., 250) to assist in imparting intelligence and functionality from the automation engine and related systems to such development tools, such as discussed later below.

In some implementations, communication between server processes of an automation engine (e.g., its component work processes 205 and communication processes 210)) may be facilitated through message queues 230. Message queues (as well as other data used to implement an automation engine instance (e.g., 232, 235, 236, 240, etc.)) may be hosted in a database implemented in connection with the automation engine and hosted on one of the computing systems of automation engine system 105. Message queues (e.g., 230) may be implemented as database tables, through which a work or communication process may post a message that may then be read and processed by another work or communication process, thereby facilitating communication between the processes. Additional queues may also be provided which contain the tasks that are to be accessed by server processes and performed in connection with an automation engine implementation. In some implementations, an automation engine instance may have multiple message queues. Depending on their types, tasks are lined up in the corresponding queue. If a work process is momentarily idle or finished with its current tasks, it will take the next queued task and process it. The execution of the task can lead to a new task for the work queue to be then attached to the current tasks. Some tasks may be dedicated tasks, which are allowed to only be processed by the primary work process. Accordingly, in such implementations, a primary work process, upon completing a preceding task, may first check (in a corresponding queue) whether any special work tasks are waiting in the queue before turning to more general work queues for generally work tasks shared with the other work processes. or this reason, the “freed-up” primary work process always checks first if any of these special work processes are present in the queue. Communication processes may utilize communication queues for communication tasks to be performed by communication processes to collect or send data from/to agents and/or UIs associated with the automation engine. In some instances, if a work process tasks involves the passing of information to agents or UIs, the work process may, as part of the performance of its task, write a new communication queue to the respective communication queue in order to prompt the communication process's involvement in the passing of this information, among other examples.

As noted above, an automation engine provided through an automation engine system 105 may be used to automate activities on various target systems (e.g., 110, 115, 120). For instance, application servers (e.g., 110, 115) hosting various applications and other software tools and programs (e.g., 245a-b) may be target systems of an automation engine. For instance, tasks automated by an automation engine may automate deployment of a new or updated version of an application or system of interoperating programs on one or more computing systems (e.g., 110, 115, 120). In other examples, a workflow involving one or more multiple different cooperating applications (e.g., 245a-c) may be automated may be automated using an automation engine, among other examples. The automation engine may interface with agents to cause functionality present on the target system to be triggered and automated according to defined automation engine tasks and jobs. In some instances, agents (e.g., 125a) may be present on an operating system (e.g., 250) of the host system (e.g., 110), on which a target application (e.g., 245a) runs. In other instances, the agent (e.g., 125b) may be present on the application (e.g., 245b) itself. During the automation of a workflow, the automation engine may communicate with and cause actions to be performed on multiple different applications (e.g., 245a-c) and host systems (e.g., 110, 115, 120) through corresponding agents (e.g., 125a-c). In automation jobs involving service orchestration or release automation, agents (e.g., 125a, c) may be used to access functionality and resources of the system that are used to deploy, install, configure, load, or otherwise automate deployment or installation of a program on one or more target systems. As an example, an application may be automatically deployed on a virtual machine using an example automation engine, through the automation engine's communication with an agent (e.g., 125c) provided on a virtual machine manager (VMM) or hypervisor (e.g., 254) that is to automatically build the host virtual machine (e.g., 260) upon which the application (e.g., 245c) is to be installed and run at the direction of the automation engine, among other examples.

In some implementations, a service manager process (e.g., 255a-c) may be present on any host system (e.g., 110, 115, 120, etc.) that is to host one or more agents (e.g., 125a-c) that are to interface and interoperate with (and at the direction) of an automation engine instance. In some implementations, a service manager (e.g., 255a-c) may manage and govern the activation and deactivation of agents (e.g., 125a-c) on the host (e.g., 110, 115, 120). Further, in cases where one or more processes (e.g., communication processes, work processes, etc.) implementing the automation engine are hosted in a distributed manner on various machines (e.g., 120), a service manager (e.g., 255c) may likewise manage and serve as the parent process of these processes (e.g., work processes 205b). As shown in the example of FIG. 2, a host system (e.g., 120) may not only host one or more agents (e.g., 125c), but may also host one or more automation engine processes (e.g., 205b), with the service manager (e.g., 255c) on the host (e.g., 120) serving as the parent process and centralized manager for all of these processes. The service manager (e.g., 255a-c) may be automatically launched in connection with the activation or reboot of a given host system (e.g., 110, 115, 120), such as on or shortly after the host system reboots. Other automation engine components (e.g., 125a-c, 205b, etc.), however, may depend on the service manager (e.g., 255a-c) for activation. The service manager may control how, when, and in what order various automation engine components are launched. The service manager may also orchestrate and manage the upgrade and installation of new agents and automation engine processes on its host, among other example functionality. The service manager may launch with elevated privileges, enabling the service manager to start sub-processed in accordance with these privileges (e.g., even if the human user does not otherwise possess such access rights), among other example features.

As further illustrated in FIG. 2, the example automation engine system 105 also includes an environment provisioning manager 280 that manages environment provisioning during an application deployment scenario. For example, in some embodiments, the environment provisioning manager 280 can access an application-specific definition of a desired target environment (which may be referred to as an “application environment blueprint”, “environment blueprint” or “blueprint”) to provision the target environment for the automated deployment of the application. That is, the release automation system (e.g., 105) may automatically establish and provision the target environment in connection with the automated deployment of the application. In existing systems, environment provisioning can be quite difficult due to a diverse array of target system and potential configurations for these systems. For instance, deployment targets may be based on virtual machine environments (e.g., VMWare) container environments (e.g., Docker), or in a cloud environment (e.g., Amazon Web Services (AWS) or Microsoft Azure). In many cases, manual provisioning may be required, introducing additional lag time in the application deployment process and potentially introducing errors (e.g., during the configuration of the target system).

Thus, in certain aspects, the automation engine system may automatically launch and configure a stack provider based on a selection of an environment blueprint by a user (e.g., in the UI 150a). The application environment blueprint may describe the structure and configuration of the target stack for a particular application or application component, upon which the application or application component is to be automatically deployed using the automation engine system. The automation engine system (e.g., through the environment provisioning manager 280) may consume the environment blueprint, which may include a stack provider template defining a stack configuration in a provider/infrastructure-independent manner, a stack provider template or other stack provider information defining aspects of the provider infrastructure onto which the stack is to be provisioned, and the automation engine system may automatically create the actual stack (sometimes referred to as a deployment target) using the blueprint. Application action packs and supporting logic (e.g., deployment agents and work processes) may then be deployed on the deployment target to automate the deployment of the application on the newly created remote stack environment. In some embodiments, a REST API can be defined to which the UI 150a is exposed, combining the provisioning of the stack application deployment automation in a single transaction (where this has been a manual two-step process up to now).

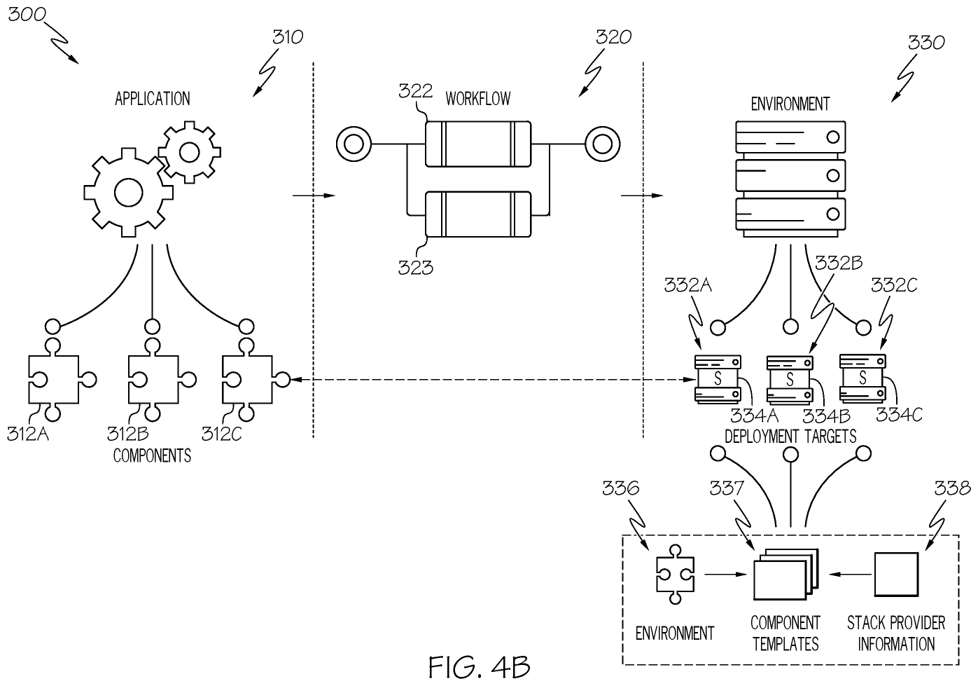

FIG. 3 is a simplified diagram of an example model 300 for application environment provisioning and application deployment within an example release automation system an example in accordance with at least one embodiment. In the example shown, an application 310 (which may be defined by the application definition) is to be deployed onto a target environment 330 (which may be defined by an environment definition). The example environment 330 includes multiple deployment targets 332, which each represent an endpoint onto which one of the application components 312 are to be deployed. For instance, in the example shown, the application 310 includes three application components 312, which may each be deployed onto a different deployment target 332 of the target environment 330.

The application 310 may be composed of multiple different components 312, which may be architected in a multi-tier and/or distributed manner. In some cases, for example, the components 312 may include one or more of a frontend (e.g., web application) server, backend (e.g., database) server, or other type of server that might be needed to implement an aspect of an overall application. An application definition may describe the attributes and architecture of an application for which a deployment is to be performed, and may define the components, how they interact, the dependencies of each, as well as other parameters describing the nature and desired configurations to be applied to the various components. Deployments performed by the release automation system may involve the deployment of a subset of one or more of the components of the defined application, such as a new component or update to an existing component, as well as deployments of an entire end-to-end application. In some embodiments, each application component 312 may utilize a specific technology (e.g., Apache Tomcat, Microsoft SQL database) and may represent a deployable application artifact package (e.g., a WAR file that may be deployed to an Apache Tomcat deployment target).

Continuing with the above example, workflow definitions 320 may also be contained within a deployment model and define the particular steps and processes (e.g., 322, 323), as well as identify the executable computer logic blocks or scripts, that are to be utilized to perform these processes (e.g., at agents installed on the target systems of the deployment). The workflow definitions 320 may be considered deployment plans and represent reusable and target-system-independent workflows, which may be reused in the deployment of multiple application and component instances of a variety of different target systems. The environment 330 may include a number of host computing devices upon which the application and its components are to be deployed. The environment 330 may be composed of multiple deployment targets 332, and an environment definition may specify attributes for use during the automated deployment (e.g., address and access information).

The application and environment definitions may provide a more global view of the application and environment within a deployment model maintained at the release automation system. Additional definitions may be composed for and used within the deployment model to identify the specific portions of the application and environment involved in a specific automated deployment process. For instance, a profile definition may define, for a deployment process, a link between a specific application component and a specific target server, such that a workflow links deployment of this component to the specific target server (e.g., shown by the dotted line in FIG. 3). A package definition may define the scope of the one or more components 312 that are to be deployed to a specific one of the target systems, identifying and describing the specific instance, versions, revisions, or tags of the collection of application artifacts that are to be deployed. Accordingly, the performance of an application deployment workflow using the release automation system involves selecting and running one of the defined workflow definitions within the context defined by a specific package definition and profile definition.

Before the application components may be deployed, the environment (and its constituent deployment targets) must first be provisioned. Typically, as described above, this requires a time consuming manual process. However, in certain aspects, the automation engine system may automate the provisioning of the environment along with the corresponding deployment of the application components. For example, in some embodiments, an environment blueprint 336 may be used to define provider/infrastructure-independent configuration information for the environment 330 and each of the different deployment targets 332 of the environment 330. The environment blueprint 336 may include multiple component templates 337, which may each define a particular deployment target configuration for a particular corresponding application component 312. The automation engine system may utilize the environment blueprint 336 along with stack provider information 338, which defines an infrastructure for a particular infrastructure provider (e.g., Docker, AWS, Azure, etc.) and/or information to access provisioning capabilities of the provider (e.g., connection information and credentials to access the provider resources), in order to automate the provisioning of the environment 330. For example, with the environment blueprint 336 and the stack provider information 338, the automation engine system may provision a stack 334 onto the hardware infrastructure of the particular provider indicated by the stack provider information 338. The automation engine system may utilize one or more workflows similar to the workflow definitions 320 to provision the environment 330. Once the environment 330 has been provisioned, the application 310 may be deployed onto the environment 330. For example, each application component 312 may be deployed onto a respective deployment target 332.

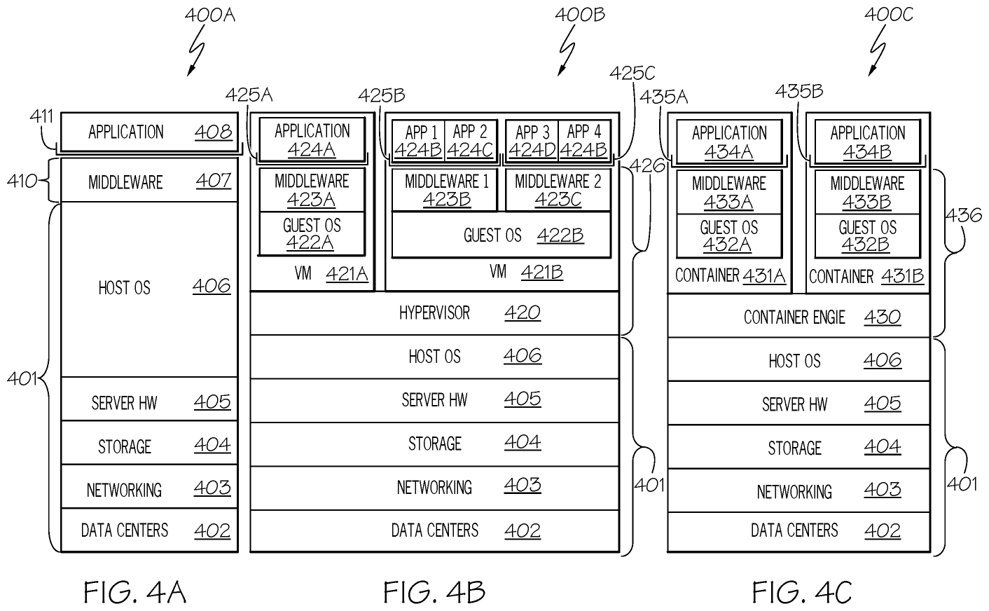

FIGS. 4A-4C are simplified block diagrams of various implementations 400 of stacks 410, 423, 443 provisioned on stack provider hardware infrastructure 401 in accordance with at least one embodiment. The stack provider infrastructure 401 includes a data center layer 402, a networking layer 403, a storage layer 404, and a server hardware layer 405. The data center layer 402 represents a combination of different server machines (either geographically co-located or geographically dispersed), the networking layer 403 represents a communication layer between the different server machines, the storage layer 404 represents storage hardware connected to the server machines, and the server hardware 405 represents the server machine-level hardware (e.g., processor, memory, etc.) upon which software runs. The server hardware 405 executes a host operating system 406 (e.g., Windows, Linux, UNIX, etc.) which may in turn execute additional software (e.g., middleware software, hypervisor software, container software, application software, etc.).

The example implementation 400A illustrates a legacy bare metal implementation of a stack with one deployment target. In the example shown, the host operating system 406 runs middleware software 407 that represents both a stack 410 and deployment target 411 onto which the application software 408 may be deployed. The implementations 400A may accordingly represent a one-to-one stack to deployment target ratio scenario. The middleware software 407 may provide services to the application software 408 beyond those provided by the host operating system 406. In some cases, the middleware software 407 may include Microsoft SQL database, Microsoft Internet Information Services (IIS), Apache Tomcat, or similar middleware software applications.

The example implementation 400B illustrates a virtual machine implementation of a stack with multiple deployment targets. In the example shown, the host operating system 406 executes a hypervisor 420 (e.g., vSphere) in which two virtual machines 421 run. The virtual machine 421A executes a first guest operating system 422A (e.g., Windows, Linux, etc.), which runs first middleware software 423A. In the example shown, the guest operating system 422A also runs application software 424A. The middleware software 423A may provide services to the application software 424A beyond those provided by the guest operating system 422A. The virtual machine 421B executes a second guest operating system 422B (e.g., Windows, Linux, etc.), which runs second middleware software 423B and third middleware software 423C. The second and third middleware software 423B, 423C may each include one or more of Microsoft SQL database, Microsoft IIS, Apache Tomcat, or another type of similar software. The guest operating system 422B also runs application software 424B-424E. The middleware software 423B may provide services to the application software 424B, 424C beyond those provided by the guest operating system 422B, and the middleware software 423C may provide services to the application software 424D, 424E beyond those provided by the guest operating system 422B. In the example shown, the combined VM/guest OS/middleware layers may represent a single stack 426, while each middleware software 423 may represent a respective deployment target 425 onto which the application software 424 may be deployed. Accordingly, the implementation 400B may represent a one-to-many stack to deployment target ratio scenario.

The example implementation 400C illustrates a container implementation of a stack with multiple deployment targets. In the example shown, the host operating system 406 executes a container engine 430 (e.g., Docker) in which two containers 431 run. The container 431A executes a first guest operating system 432A (e.g., Windows, Linux, etc.), which runs first middleware software 433A. In the example shown, the guest operating system 432A also runs first application software 434A. The middleware software 433A may provide services to the application software 434A beyond those provided by the guest operating system 432A. Likewise, the container 431B executes a second guest operating system 432B (e.g., Windows, Linux, etc.), which runs second middleware software 433B. In the example shown, the guest operating system 432B also runs second application software 434B. The middleware software 433B may provide services to the application software 434B beyond those provided by the guest operating system 432B. In the example shown, the combined container/guest OS/middleware layers may represent a single stack 436, while each middleware software 433 may represent a respective deployment target 435 onto which the application software 434 may be deployed. Accordingly, the implementation 400C may represent a one-to-many stack to deployment target ratio scenario similar to the implementation 400B.

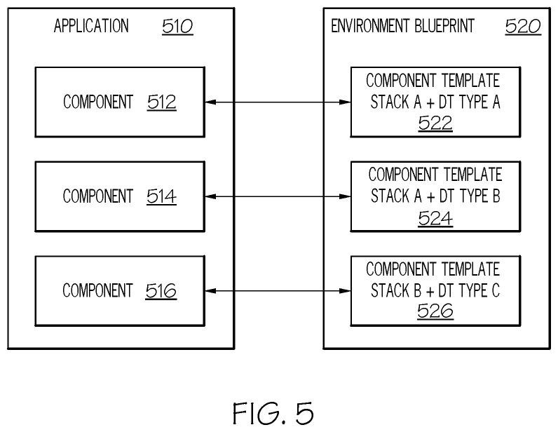

FIG. 5 is a simplified block diagram illustrating relationships between an application 510 and an environment blueprint 520 in accordance with at least one embodiment. In the example shown, the application 510 includes three application components 512, 514, 516. Each application component may represent a respective layer or tier of the overall application 510. For example, in some instances, the application component 512 may represent a frontend web server application component, the application component 514 may represent a middle tier business logic/processing component, and the application component 516 may represent a backed database server application component.

In the example shown, each application component has a corresponding component template of the environment blueprint 520. For instance, the application component 512 has a corresponding component template 522, the application component 514 has a corresponding component template 524, and the application component 516 has a corresponding component template 526. Each component template may indicate a stack and deployment target type that make up the deployment target for the corresponding application component. As an example, the component template may indicate that a particular application component has a corresponding stack that is a virtual machine instance running Windows 2008r2 and Apache Tomcat, and a deployment target type of Apache Tomcat. In the example shown, the component templates 522, 524 both indicate a stack “A”, while the component template 526 indicates a stack “B”. Each component template indicates a different deployment target type.

In some embodiments, each component template may point to a particular stack template corresponding to the indicated stack and a deployment target template corresponding to the indicated deployment target type. In some cases, the environment blueprint 520 may include the stack templates and deployment target templates indicated by the different component templates. For instance, referring to the example shown, the blueprint 520 may include a stack template for each of the stacks A and B (to which the component templates point to), and a deployment target template for each of the deployment target types A, B, C (to which the component templates point to). In other cases, the stack template and/or deployment target template are stored elsewhere. The stack template may map a deployment target type/middleware to the indicated stack (e.g., virtual machine(s), container(s), bare metal, etc.), while the deployment target template may map the configuration of the actual deployment target middleware.

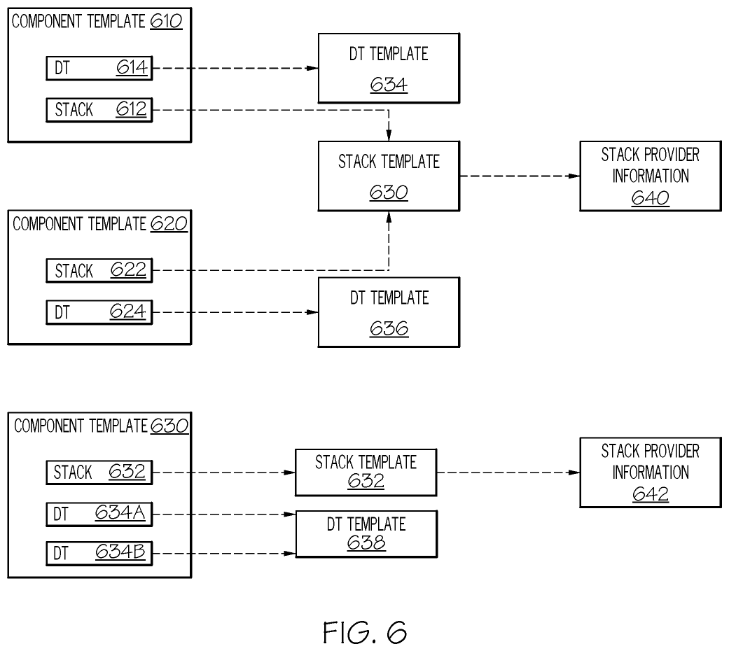

FIG. 6 is a simplified block diagram showing example relationships between component templates (e.g., 610, 620, 630), stack templates (e.g., 630, 632), deployment target templates (e.g., 634, 636, 638), and stack provider information (e.g., 640, 642) in accordance with at least one embodiment. The component templates 610, 620, 630 may each be configured similar to the component templates of FIG. 5, and may be part of an overall application environment blueprint (e.g., similar to blueprint 520 of FIG. 5).

In the example shown, the component templates (e.g., 610, 620, 630) each include an indicator for a stack (e.g., 612, 622, 632) and an indicator for a deployment target type (e.g., 614, 624, 634). In some embodiments, the indicators may include pointers that point to the corresponding stack templates and deployment target templates. For instance, the stack indicators 612, 622 may be separate pointers that point to the same stack template 632 as shown where the stacks indicated for each application component corresponding to the component templates 610, 620 are the same stack. The stack templates may each point to particular stack provider information (e.g., 640, 642). In some instances, a component template may indicate multiple deployment targets for each stack (e.g., in virtual machine or container implementations, such as those shown in implementations 400B, 400C of FIGS. 4B, 4C). For example, the component template 630 has one stack indicator 6320 and two deployment target type indicators 634.

The stack templates may define provider- or infrastructure-independent configuration information for the stack indicated by the component template. The stack template may accordingly provide a reusable application component for different stack/infrastructure providers. The stack template may map a deployment target type to the stack on which it is to run. In some cases, the stack templates are formatted according to a JavaScript Object Notation (JSON) format, and include metadata to describe the configuration information for the stack indicated. In some cases, the stack templates may indicate an image that may be used to provision the indicated stack. For example, the stack template may indicate a virtual machine image (e.g., a VMWare image), a container image (e.g., a Docker template), or a virtual appliance image (e.g., an AWS AMI). The image may be indicated in the stack template through any suitable means. For example, the image may be indicated using an image name and/or web location (e.g., IP address) of the image. For virtual machine (e.g., VMWare) images, for instance, the configuration information may indicate a datacenter, datastore, location type or name, virtual machine host, or other information about the image. For virtual appliance images (e.g., AWS AMIs), the configuration information may include an image identifier, an option to allocate a public IP address, an instance type, key pair information, user data/user data file information, kernel information, ramdisk information, subnet information, or other information about the image.

The deployment target templates may define provider- or infrastructure-independent configuration information for the deployment target type indicated by the component template. The deployment target template may refer to a particular deployment target and serve as a pattern for provisioning additional deployment targets of the same type. A deployment target may refer to an endpoint in a deployment model, e.g., the deployment target endpoints 332 of FIG. 3. Each deployment target may be linked to an agent, and an agent may serve multiple deployment targets. A deployment target may describe connection information for a physical endpoint (e.g., credential information, such as username and password information, IP address information, or other connection information) to enable deployment of application components onto the endpoint. In some cases, the deployment target templates are formatted according to a JavaScript Object Notation (JSON) format, and include metadata to describe the configuration information for the deployment target type indicated.

The stack provider information includes information indicating a particular provisioning infrastructure on which the stack indicated by the corresponding stack template is to be provisioned. The stack provider may indicate an internal datacenter infrastructure or external/cloud provider (e.g., VMWare, Docker, AWS, Azure, etc.) infrastructure. The stack provider information may also include connection information indicating how to access resources of the infrastructure provider. For example, the stack provider information may include one or more of (depending on the stack provider type) a uniform resource locator (URL) for a daemon (e.g., a Docker daemon URL), a server address for a hypervisor (e.g., a vSphere server address), and credential information for the infrastructure provider (e.g., vSphere or AWS credentials, such as a username and password). In some cases, the stack provider information includes an application programming interface (API) that may be used for provisioning a stack on the provisioning infrastructure of the provider.

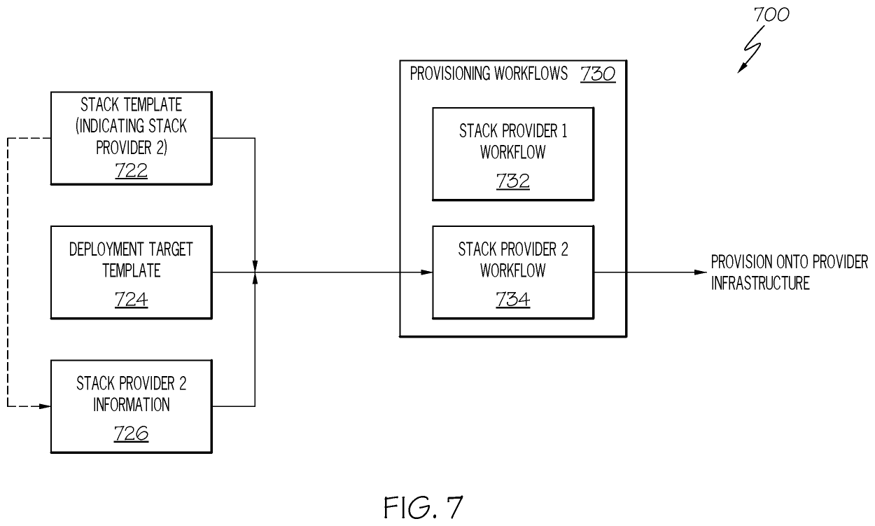

FIG. 7 is a simplified block diagram illustrating an example process 700 of selecting a provisioning workflow based on a stack template 722, a deployment target template 724, and stack provider information 726 in accordance with at least one embodiment. In the example shown, the stack template 722 and deployment target template 724 may correspond to or be associated with a particular component template (e.g., component templates 610, 620, 630). The component template may have been selected to be provisioned onto provider infrastructure to provide a deployment target onto which application component software may be deployed. The stack template 722 points to the stack provider information 726 that corresponds to a second provider (Stack Provider 2) of multiple stack providers. To provision the deployment target, a workflow is selected from among the provisioning workflows 730. In the example shown, because the stack template points to the stack provider information 736 for Stack Provider 2, the Provider 2 workflow 734 may be selected. In some cases, the workflow may be selected on other factors.

Each of the provisioning workflows 730 may describe a set of steps and/or operations for provisioning a deployment target onto provider hardware infrastructure based on the information contained in the stack template, the deployment target template, and the stack provider information. For example, the provisioning workflow may include provider-specific steps for provisioning a stack at the provider's infrastructure. The workflow may access the stack provider information during the provisioning (e.g., to access a particular account on a cloud provider, such as AWS or Azure), and may access the configuration information in the stack template and deployment target template to configure the instance of the stack on the provider's specific infrastructure.

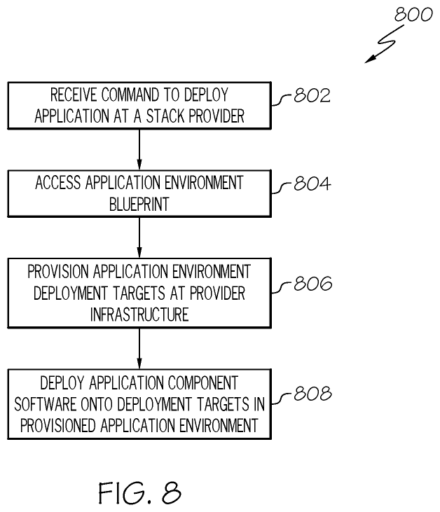

FIG. 8 is a flow diagram of an example process of provisioning an application environment in accordance with at least one embodiment. Operations in the example process 800 may be performed by components of an automation engine system (e.g., at least in part by the environment provisioning manager 280 of the automation engine system 105 of FIG. 2). The example process 800 may include additional or different operations, and the operations may be performed in the order shown or in another order. In some cases, one or more of the operations shown in FIG. 8 are implemented as processes that include multiple operations, sub-processes, or other types of routines. In some cases, operations can be combined, performed in another order, performed in parallel, iterated, or otherwise repeated or performed another manner.

At 802, a command to deploy an application at a stack provider is received. The command may be provided by a user through an interface on a computing device and received at an automation engine system. For instance, referring to the example shown in FIG. 2, a user may send a command to the automation engine system 105 via the UI 150a on computing device 135. The command may be processed by the automation engine system to initiate one or more workflows to provision a target environment for the application and deploy application component software onto the target environment as described herein.

At 804, an application environment blueprint is accessed. The environment blueprint may provide provider- or infrastructure-independent configuration information that may be used to provision the target environment for the application selected for deployment at 802. In some cases, the application environment blueprint is accessed in response to a selection. The selection may be manual, e.g., by a user, or automatic. For example, in some cases, the application environment blueprint may be selected by a machine learning algorithm based on the command received at 802. The machine learning algorithm may select the blueprint, for example, based on a best match for a purpose of the environment (e.g., regression testing, load testing, etc.).

The environment blueprint may include a set of component templates that correspond to different components of an application. For instance, referring to the example shown in FIG. 5, the environment blueprint 520 includes a component template corresponding to each of the application components. Each component template may indicate (e.g., using a pointer) a particular stack and deployment target type. For example, the component template may point to a stack template and a deployment target template, e.g., as shown in FIG. 6, that define (in an infrastructure/provider-independent manner) a deployment target to be provisioned. The stack template and deployment target template may be implemented as described above, and may be formatted in a JSON file format. In some cases, the environment blueprint may be accessed through a REST API GET command, which may output a JSON format file containing the environment blueprint information. For example, a user may provide a blueprint file location as a parameter to the GET command, and the REST API may output a JSON format file which may be edited and/or used to provision an environment as described further below.

At 806, an application environment is provisioned at the stack provider infrastructure based on the application environment blueprint. Provisioning the environment may include creating one or more deployment targets onto which application software may be deployed. This provisioning may include, for example, provisioning, for each stack template of the blueprint accessed at 804, a stack on the provisioning infrastructure that is indicated by the stack provider information corresponding to the stack template. For instance, referring to the example shown in FIG. 4B, provisioning the stack may include provisioning the hypervisor 420 and the virtual machines onto the hypervisor. In some embodiments, provisioning the stack may involve provisioning an image of the stack onto the infrastructure. In some embodiments, a stack provisioning workflow may be selected based on the stack provider information corresponding to the stack template to provision the stack onto the infrastructure. For instance, referring to the example shown in FIG. 7, the workflow 734 is selected (over the workflow 732) based on the stack provider indicated by the stack template 722 and/or the stack provider information 726.

Once the stack has been provisioned on the infrastructure, the middleware indicated by the deployment target template of the blueprint accessed at 804 may be provisioned onto the stack. Referring again to the example shown in FIG. 4B, this may include provisioning the middleware 423A, 423B, 423C onto the virtual machines to provide the deployment targets 425A, 425B, 425C. In some cases, the environment may be provisioned through a REST API POST command. For example, a user may provide the blueprint file location as a parameter to the POST command, and the REST API may initiate a command to provision an environment based on a JSON format file at the blueprint file location. In some implementations, the JSON file may be presented to a user prior to initiating the POST command so that the user may edit one or more aspects of the blueprint prior to provisioning.

At 808, application component software is deployed in the provisioned application environment. This may include deploying an application package (e.g., WAR files) onto each of the stacks/deployment targets of the provisioned environment. For instance, referring to the example shown in FIG. 3, an application package for component 312A may be deployed onto the stack 334A of deployment target 332A, an application package for component 312B may be deployed onto the stack 334B of deployment target 332B, and an application package for component 312C may be deployed onto the stack 334C of deployment target 332C.

The application software may then be utilized in any appropriate manner. For instance, the application software may be used in a test environment, a production environment, or another environment. In some cases, the application environment may be de-provisioned later on, e.g., after certain tests are executed on a test application environment.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
receiving a command to initiate deployment of an application instance;
accessing a particular environment blueprint from a plurality of environment blueprints based on the application indicated in the command, the particular environment blueprint comprising a plurality of component templates corresponding to respective application components, each component template indicating:
a stack template defining provider-independent configuration information for a particular stack, the stack template pointing to particular stack provider information indicating a provisioning infrastructure for the stack; and
a deployment target template defining provider-independent configuration information for middleware to serve as an application deployment target;
provisioning an application environment based on the environment blueprint, wherein the environment comprises multiple application deployment targets, each application deployment target comprising middleware corresponding to a particular deployment target template of the particular environment blueprint that runs on a stack corresponding to a particular stack template of the particular environment blueprint; and
deploying application components on the application deployment targets of the provisioned environment based on the particular environment blueprint.

2. The method of claim 1, wherein provisioning the environment comprises:
provisioning, for each stack template indicated in the particular environment blueprint, a stack on the provisioning infrastructure indicated by the stack provider; and
provisioning, at each provisioned stack, the middleware indicated by the deployment target template.

3. The method of claim 1, wherein provisioning the environment comprises selecting, for each stack template indicated in the particular environment blueprint based at least on the stack provider corresponding to the stack template, a stack provisioning workflow to provision the stack indicated by the stack template.

4. The method of claim 1, wherein at least one component template comprises multiple deployment target templates corresponding to one stack template.

5. The method of claim 1, wherein the stack template comprises information identifying a particular image for use in provisioning the stack.

6. The method of claim 5, wherein the image includes a virtual machine template, a container image, or a virtual appliance template.

7. The method of claim 1, wherein the stack provider information comprises an application programming interface (API) for provisioning a stack on the provisioning infrastructure.

8. The method of claim 1, wherein the stack provider information comprises connection information for the infrastructure provider, comprising one or more of a uniform resource locator (URL) for a daemon, a server address for a hypervisor, and credential information for the infrastructure provider.

9. The method of claim 1, wherein deploying application components on the application deployment targets of the provisioned environment comprises deploying application packages on each stack of the provisioned environment based on an application deployment workflow.

10. The method of claim 1, wherein the particular environment blueprint is formatted according to a JavaScript Object Notation (JSON) format, and includes metadata to describe the configuration information for the stack templates and deployment targets of the particular environment blueprint.

11. The method of claim 1, wherein:
the environment blueprint is accessed in response to a GET command of a Representational State Transfer (REST) API; and
the application environment is provisioned in response to a POST command of the REST API.

12. A non-transitory computer readable medium having program instructions stored therein, wherein the program instructions are executable by a computer system to perform operations comprising:
accessing a stack template in response to a request to provision an application environment, the stack template defining provider-independent configuration information for a particular stack;
accessing a deployment target template corresponding to the stack template, the deployment target template defining provider-independent configuration information for middleware;
selecting a provisioning workflow based at least on stack provider information indicated by the stack template, the stack provider information indicating an infrastructure for provisioning the particular stack indicated by the stack template; and
provisioning a stack on the infrastructure based on the selected workflow, the stack template, and the stack provider information; and
provisioning middleware on the provisioned stack based on the deployment target template.

13. The non-transitory computer readable medium of claim 12, wherein the operations further comprise deploying application software onto the provisioned middleware.

14. The non-transitory computer readable medium of claim 12, wherein the stack template is formatted according to a JavaScript Object Notation (JSON) format, and includes metadata to describe the configuration information for the particular stack.

15. The non-transitory computer readable medium of claim 12, wherein the stack template comprises identifies a virtual machine image, a container image, or a virtual appliance image.

16. The non-transitory computer readable medium of claim 12, wherein the deployment target template is formatted according to a JavaScript Object Notation (JSON) format, and includes metadata to describe the configuration information for the middleware.

17. The non-transitory computer readable medium of claim 12, wherein the provisioning workflow defines a set of operations for provisioning a stack at the stack provider infrastructure.

18. The non-transitory computer readable medium of claim 12, wherein provisioning the stack on the infrastructure comprises using an application programming interface (API) of the stack provider information to provision the stack on the infrastructure.

19. The non-transitory computer readable medium of claim 12, wherein the stack provider information comprises provisioning server information indicating a server address for accessing provisioning resources of the stack provider.

20. A system comprising:
a data processing apparatus;
a memory; and
an environment provisioning manager, executable by the data processing apparatus to:
access a stack template in response to a request to provision an application environment, the stack template defining provider-independent configuration information for a particular stack;
access a deployment target template corresponding to the stack template, the deployment target template defining provider-independent configuration information for middleware;
select one or more provisioning workflows based at least on stack provider information indicated by the stack template, the stack provider information indicating an infrastructure for provisioning the particular stack indicated by the stack template; and
provision a deployment target on infrastructure of the stack provider based on the selected provisioning workflow, the deployment target comprising a stack provisioned on the infrastructure that corresponds to the stack template and middleware on the stack that corresponds to the deployment target template.
